(19) United States
(12) Patent Application Publication
(10) Pub. No.: US 2019/0310523 A1
(43) Pub. Date: Oct. 10, 2019

(54) MANUFACTURING METHOD OF LIQUID CRYSTAL DISPLAY PANEL AND LIQUID CRYSTAL MEDIUM COMPOSITION

(71) Applicant: Shenzhen China Star Optoelectronics Semiconductor Display Technology Co., Ltd., Shenzhen (CN)

(72) Inventor: Song LAN, Shenzhen (CN)

(21) Appl. No.: 15/776,088

(22) PCT Filed: May 7, 2018
(86) PCT No.: PCT/CN2018/085781

§ 371 Date: May 15, 2018

(30) Foreign Application Priority Data
Apr. 9, 2018 (CN) 201810308915.7

(51) Int. Cl. G02F 1/1337; C08L 33/08; C08F 2/48

(52) U.S. Cl. CPC G02F 1/133711; G02F 1/133788; C08L 2203/16; C08F 2/48; C08L 2203/20; C08L 33/08

(57) ABSTRACT

A manufacturing method of a liquid crystal display panel and a liquid crystal medium composition are provided. A photoinitiator and flexible branched chains-containing active monomers are added into the liquid crystal material, and a special process condition is used. Thus, a traditional alignment film process can be omitted, and liquid crystal alignment is accomplished. Furthermore, impurity ions are prevented from diffusing into a liquid crystal layer, and quality of the liquid crystal display panel is greatly enhanced.

### CROSS REFERENCE TO RELATED APPLICATIONS

This application is a U.S. National Phase application submitted under 35 U.S.C. § 371 of Patent Cooperation Treaty Application serial No. PCT/CN2018/085781, filed on May 7, 2018, which claims the priority of China Patent Application serial No. 201810308915.7, filed on Apr. 9, 2018, the disclosures of which are incorporated herein by reference in their entirety.

### FIELD OF INVENTION

The present disclosure relates to the field of display technologies, and more particularly to manufacturing methods of liquid crystal display panels, and liquid crystal medium compositions.

### BACKGROUND OF INVENTION

A thin film material is disposed on both a CF substrate and a TFT substrate of a liquid crystal display panel. Primary role of the thin film material is to align liquid crystal molecules in a particular direction, thus the thin film material is called an alignment film. The alignment film is mainly divided into a rubbing alignment type material and lighting alignment type material. However, both rubbing alignment type material and lighting alignment type material have their own disadvantages. First, the rubbing alignment type material poses problems of generating powder particles, residual electrostatic, brush marks, etc., which reduce process yield. Although these problems can be avoided by using the lighting alignment type material, material characteristics of the lighting alignment type material are limited, and heat resistance and aging resistance of the lighting alignment type material are poor. Meanwhile, ability of anchoring the liquid crystal molecules is relatively weak so quality of the liquid crystal display panel is influenced. Secondly, the rubbing alignment type material and the lighting type material have high polarity and high hygroscopicity; therefore, they are prone to deterioration and lead to non-uniform distribution during storage and transportation. Because the materials are expansive and the film forming process on the liquid crystal display panel is also relatively complicated, the cost of the liquid crystal display panel is increased.

If the alignment film in a liquid crystal display panel is omitted, the liquid crystal molecules cannot be uniformly aligned which lead to a display abnormity of the liquid crystal display panel. A present commonly used process is to add an additive material into the liquid crystals to achieve the purpose for replacing the alignment film. The additive materials comprise nanoparticle polyhedral oligomeric silsesquioxane, amine branched macromolecules, cetyl trimethyl ammonium bromide, an alcohol micromolecular material and the like.

However, when these additive materials are applied to the liquid crystals, the polar groups of those additive materials pollute the liquid crystals and result in a liquid crystal display panel with a relatively bad quality.

### SUMMARY OF INVENTION

The purposes of the embodiments of the present disclosure are to provide a method for manufacturing a liquid crystal display panel, and a liquid crystal medium composition. A photoinitiator and flexible branched chains-containing active monomers are added into the liquid crystal material, and a special process condition is used. Thus, a traditional alignment film process can be omitted, and liquid crystal alignment is accomplished. Furthermore, impurity ions are prevented from diffusing into a liquid crystal layer, and quality of the liquid crystal display panel is greatly enhanced.

In order to achieve the foregoing purposes, an embodiment of the present disclosure provides a manufacturing method of a liquid crystal display panel, comprising steps of:

providing an upper substrate, a lower substrate, and a liquid crystal medium composition, wherein the liquid crystal medium composition comprises a liquid crystal material, a photoinitiator, and flexible branched chains-containing active monomers, wherein the liquid crystal material comprises liquid crystal molecules;

dripping the liquid crystal medium composition onto one of the upper substrate and the lower substrate, coating a sealant on a region of the upper substrate and the lower substrate corresponding to a periphery of the liquid crystal medium composition, assembling and attaching the upper substrate with the lower substrate, and curing the sealant, wherein a liquid crystal layer is formed by the liquid crystal medium composition which is disposed between the upper substrate and the lower substrate;

heating the liquid crystal layer, and after a conformation of the liquid crystal molecule changes, applying a first ultraviolet irradiation to the liquid crystal layer while heating, such that a portion of the active monomers react with the photoinitiator and the active monomers are deposited on both the upper substrate and the lower substrate, thus aligning the liquid crystal molecules perpendicular to the upper substrate and the lower substrate; and

applying a voltage to two sides of the liquid crystal layer, and after the liquid crystal molecules are deflected, applying a second ultraviolet irradiation to the liquid crystal layer while applying the voltage, such that another portion of the active monomers react with the photoinitiator and the active monomers continue to be deposited on both the upper substrate and the lower substrate, and the liquid crystal molecules generate a pretilt angle;

wherein after the step of applying voltage to the two sides of the liquid crystal layer, and after the liquid crystal molecules are deflected, applying the second ultraviolet irradiation to the liquid crystal layer while applying the voltage, such that the another portion of the active monomers react with the photoinitiator, causing continued deposition of the active monomers on both the upper substrate and the lower substrate, thus having the liquid crystal molecules generate the pretilt angle, the method further comprises:

removing the voltage which is applied to the two sides of the liquid crystal layer, and then applying a third ultraviolet irradiation to the liquid crystal layer, such that the active monomers completely react with the photoinitiator; and

wherein in relation to the liquid crystal medium composition, a mass percentage of the liquid crystal material is 94.5%-98.9%, a mass percentage of the active monomers is 1%-5%, and a mass percentage of the photoinitiator is 0.1%-0.5%.

In the manufacturing method of the liquid crystal display panel, wherein a duration for applying the first ultraviolet light irradiation to the liquid crystal layer is between 1 minute to 60 minutes, and a duration for applying the second ultraviolet light irradiation to the liquid crystal layer is between 30 seconds to 200 seconds, and a duration for applying the third ultraviolet light irradiation to the liquid crystal layer is between 30 minutes to 100 minutes.

In the manufacturing method of the liquid crystal display panel, wherein the first ultraviolet irradiation, the second ultraviolet light irradiation, and the third ultraviolet light irradiation cause the active monomers to react with the photoinitiator, and a first polymer layer and a second polymer layer are formed on the upper substrate and the lower substrate, respectively, wherein a thickness of each of the first polymer layer and the second polymer layer is between 200 angstroms to 1200 angstroms.

In the manufacturing method of the liquid crystal display panel, wherein the active monomers are at least one of:

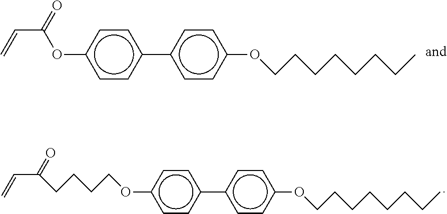

In the manufacturing method of the liquid crystal display panel, wherein the photoinitiator is one of azobisisobutyronitrile, dialkyl peroxides, diacyl peroxides, peroxy esters, and any combination thereof.

In the manufacturing method of the liquid crystal display panel, wherein the liquid crystal layer is heated to a temperature of 70° C. to 100° C.

In the manufacturing method of the liquid crystal display panel, wherein an intensity of each of the first ultraviolet light irradiation, the second ultraviolet light irradiation and the third ultraviolet light irradiation is between 85 mW/cm² to 100 mW/cm².

In order to achieve the foregoing purposes, an embodiment of the present disclosure further provides a manufacturing method of the liquid crystal display panel, comprises steps of:

providing an upper substrate, a lower substrate, and a liquid crystal medium composition, wherein the liquid crystal medium composition comprises a liquid crystal material, a photoinitiator, and flexible branched chains-containing active monomers, wherein the liquid crystal material comprises liquid crystal molecules;

dripping the liquid crystal medium composition onto one of the upper substrate and the lower substrate, coating a sealant on a region of the upper substrate and the lower substrate corresponding to a periphery of the liquid crystal medium composition, assembling and attaching the upper substrate with the lower substrate, and curing the sealant, wherein a liquid crystal layer is formed by the liquid crystal medium composition which is disposed between the upper substrate and the lower substrate;

heating the liquid crystal layer, and after a conformation of the liquid crystal molecule changes, applying a first ultraviolet irradiation to the liquid crystal layer while heating, such that a portion of the active monomers react with the photoinitiator and the active monomers are deposited on both the upper substrate and the lower substrate, thus aligning the liquid crystal molecules perpendicular to the upper substrate and the lower substrate; and

applying a voltage to two sides of the liquid crystal layer, and after the liquid crystal molecules are deflected, applying a second ultraviolet irradiation to the liquid crystal layer while applying the voltage, such that another portion of the active monomers react with the photoinitiator, causing continued deposition of the active monomers on both the upper substrate and the lower substrate, and the liquid crystal molecules generate a pretilt angle.

In the manufacturing method of the liquid crystal display panel, wherein after the step of applying voltage to the two sides of the liquid crystal layer, and after the liquid crystal molecules are deflected, applying the second ultraviolet irradiation to the liquid crystal layer while applying the voltage, such that the another portion of the active monomers react with the photoinitiator, causing continued deposition of the active monomers on both the upper substrate and the lower substrate, thus having the liquid crystal molecules generate the pretilt angle, the method further comprises:

removing the voltage which is applied to the two sides of the liquid crystal layer, and then applying a third ultraviolet irradiation to the liquid crystal layer, such that the active monomers completely react with the photoinitiator.

In the manufacturing method of the liquid crystal display panel, wherein a duration for applying the first ultraviolet light irradiation to the liquid crystal layer is between 1 minute to 60 minutes, and a duration for applying the second ultraviolet light irradiation to the liquid crystal layer is between 30 seconds to 200 seconds, and a duration for applying the third ultraviolet light irradiation to the liquid crystal layer is between 30 minutes to 100 minutes.

In the manufacturing method of the liquid crystal display panel, wherein the first ultraviolet irradiation, the second ultraviolet light irradiation, and the third ultraviolet light irradiation cause the active monomers to react with the photoinitiator, and a first polymer layer and a second polymer layer are formed on the upper substrate and the lower substrate, respectively, wherein a thickness of each of the first polymer layer and the second polymer layer is between 200 angstroms to 1200 angstroms.

In the manufacturing method of the liquid crystal display panel, wherein in relation to the liquid crystal medium composition, a mass percentage of the liquid crystal material is 94.5%-98.9%, a mass percentage of the active monomers is 1%-5%, and a mass percentage of the photoinitiator is 0.1%-0.5%.

In the manufacturing method of the liquid crystal display panel, wherein the active monomers are at least one of:

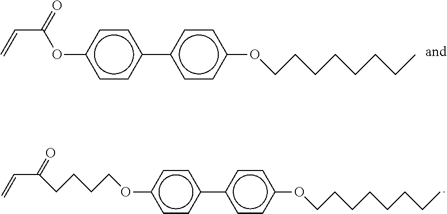

In the manufacturing method of the liquid crystal display panel, wherein the photoinitiator is one of azobisisobutyronitrile, dialkyl peroxides, diacyl peroxides, peroxy esters, and any combination thereof.

In the manufacturing method of the liquid crystal display panel, wherein the liquid crystal layer is heated to a temperature of 70° C. to 100° C.

In the manufacturing method of the liquid crystal display panel, wherein an intensity of each of the first ultraviolet light irradiation, the second ultraviolet light irradiation and the third ultraviolet light irradiation is between 85 mW/cm² to 100 mW/cm².

According to the foregoing purposes of the invention, the invention further provides a liquid crystal medium composition, comprising:

a liquid crystal material, a photoinitiator, and flexible branched chains-containing active monomers, wherein the liquid crystal material comprises liquid crystal molecules;

wherein the active monomers are at least one of:

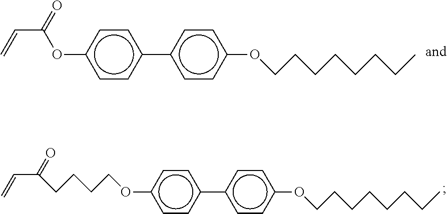

wherein the photoinitiator is one of azobisisobutyronitrile, dialkyl peroxides, diacyl peroxides, peroxy esters, and any combination thereof; and

wherein in relation to the liquid crystal medium composition, a mass percentage of the liquid crystal material is 94.5%-98.9%, a mass percentage of the active monomers is 1%-5%, and a mass percentage of the photoinitiator is 0.1%-0.5%.

The advantages of the present disclosure: The present disclosure provides a manufacturing method of the liquid crystal display panel, and the liquid crystal medium composition. A photoinitiator and flexible branched chains-containing active monomers are added into the liquid crystal material, and a special process condition is used. Thus, a traditional alignment film process can be omitted, and liquid crystal alignment is accomplished. Furthermore, impurity ions are prevented from diffusing into a liquid crystal layer, and quality of the liquid crystal display panel is greatly enhanced.

### DESCRIPTION OF DRAWINGS

In order to illustrate a technical solution in the embodiments or in the prior art more clearly, the accompanying drawings required in the description of the embodiments or the prior art are introduced briefly hereafter. It is obvious that the accompanying drawings in the following description are merely part of the embodiments of the present disclosure. People with ordinary skills in the art can obtain other drawings without making inventive efforts.

FIG. 1 is a flow chart of a method for manufacturing a liquid crystal display panel of an embodiment of the present disclosure. The embodiment of the present disclosure provides a manufacturing method of a liquid crystal display panel.

FIG. 2 is a schematic view of step S101 and step S102 of the method for manufacturing a liquid crystal display panel of the embodiment of the present disclosure.

FIG. 3 is a schematic diagram of step S103 of the method for manufacturing a liquid crystal display panel of the embodiment of the present disclosure.

FIG. 4 is a schematic diagram of step S103 of the method for manufacturing a liquid crystal display panel of the embodiment of the present disclosure.

FIG. 5 is a schematic diagram of step S105 of the method for manufacturing a liquid crystal display panel of the embodiment of the present disclosure.

### DETAILED DESCRIPTION OF PREFERRED EMBODIMENTS

Embodiments of the present disclosure will be described in detail in the following descriptions, examples of which are shown in the accompanying drawings, in which the same or similar reference numerals represent the same or similar elements or elements having the same or similar functions throughout the descriptions. The embodiments described hereinafter with reference to the accompanying drawings are explanatory and illustrative, which are used to generally understand the present disclosure, but shall not be construed to limit the present disclosure.

The technical solutions of the embodiments of the present disclosure will be illustrated completely and clearly in combination with the following drawings of the embodiments of the disclosure. Apparently, the described embodiments are merely a few rather than all of the embodiments of the present disclosure. All other embodiments obtained by persons of ordinary skill in the art based on the embodiment of the present disclosure without creative efforts shall fall within the protection scope of the present disclosure.

In the specification, claims, and accompanying drawings of the present disclosure, the terms “first”, “second”, “third”, “fourth”, and so on (if exist), are intended to distinguish between similar objects but do not necessarily indicate specific order or a specific sequence. It is appreciated that the data termed in such a way are interchangeable in proper circumstances so that the embodiments of the present disclosure described herein can be implemented in order except the order illustrated or described herein. Moreover, the terms “include”, “contain” and any other variants mean to cover the non-exclusive inclusion, for example, a device, terminal system that includes a series of steps, methods or includes a series of modules or units are not necessarily limited to those listed steps or modules or units, may further include other steps or modules or units which are not expressly listed or include other steps or modules or units which is inherent to such a process, method, device, terminal, or system.

Various embodiments and examples are provided in the following descriptions to implement different structures of the present disclosure. In order to simplify the present disclosure, elements and arrangements for certain examples will be described. However, these elements and arrangements are only by way of example and are not intended to limit the present disclosure. In addition, reference numerals and/or reference letters may be repeated in different examples in the present disclosure, those repeat is for the purpose of simplification and clarity and does not refer to relations between different embodiments and/or settings. Furthermore, examples of specific processes and materials are provided in the present disclosure, however, it would be appreciated by those ordinary skilled in the art that other processes and/or materials may be also applied.

First, the present disclosure provides a liquid crystal medium composition, comprising a liquid crystal material, a photoinitiator, and flexible branched chains-containing active monomers. The liquid crystal material comprises liquid crystal molecules.

Wherein the flexible branched chains contained in the active monomers are at least one of:

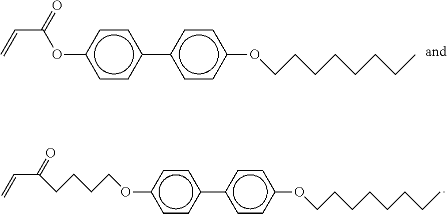

Wherein the photoinitiator is one of azobisisobutyronitrile, dialkyl peroxides, diacyl peroxides, peroxy esters, and any combination thereof.

Specifically, in relation to the liquid crystal medium composition, a mass percentage of the liquid crystal material is 94.5%-98.9%, a mass percentage of the active monomers is 1%-5%, and a mass percentage of the photoinitiator is 0.1%-0.5%.

It should be noted that the manufacturing method of the liquid crystal display panel provided by the present disclosure is mainly by the liquid crystal medium composition provided hereabove and a special process condition is applied. Not only can the liquid crystal molecules be uniformly aligned, but also impurity ions in the liquid crystal display panel can be prevented from diffusing into the liquid crystal layer, and quality of the liquid crystal display panel is greatly increased.

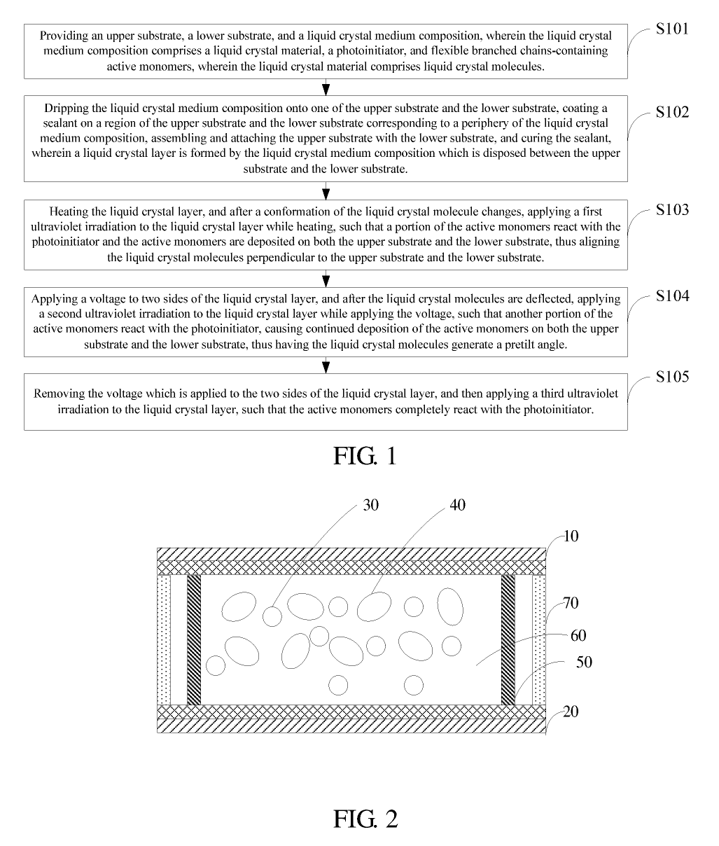

Please refer to FIG. 1, where FIG. 1 is a flow chart of a method for manufacturing a liquid crystal display panel of an embodiment of the present disclosure. The embodiment of the present disclosure provides a manufacturing method of a liquid crystal display panel, comprising the following steps of:

S101: providing an upper substrate, a lower substrate, and a liquid crystal medium composition, wherein the liquid crystal medium composition comprises a liquid crystal material, a photoinitiator, and flexible branched chains-containing active monomers, wherein the liquid crystal material comprises liquid crystal molecules;

S102: dripping the liquid crystal medium composition onto one of the upper substrate and the lower substrate, coating a sealant on a region of the upper substrate and the lower substrate corresponding to a periphery of the liquid crystal medium composition, assembling and attaching the upper substrate with the lower substrate, and curing the sealant, wherein a liquid crystal layer is formed by the liquid crystal medium composition which is disposed between the upper substrate and the lower substrate;

S103: heating the liquid crystal layer, and after a conformation of the liquid crystal molecule changes, applying a first ultraviolet irradiation to the liquid crystal layer while heating, such that a portion of the active monomers react with the photoinitiator and the active monomers are deposited on both the upper substrate and the lower substrate, thus aligning the liquid crystal molecules perpendicular to the upper substrate and the lower substrate; and

S104: applying a voltage to two sides of the liquid crystal layer, and after the liquid crystal molecules are deflected, applying a second ultraviolet irradiation to the liquid crystal layer while applying the voltage, such that another portion of the active monomers react with the photoinitiator, causing continued deposition of the active monomers on both the upper substrate and the lower substrate, and the liquid crystal molecules generate a pretilt angle;

Please refer to FIG. 2, where FIG. 2 is a schematic view of step S101 and step S102 of the method for manufacturing a liquid crystal display panel of the embodiment of the present disclosure. In step S101, providing an upper substrate 10, a lower substrate 20, and a liquid crystal medium composition, wherein the liquid crystal medium composition comprises a liquid crystal material, a photoinitiator, and flexible branched chains-containing active monomers 30, wherein the liquid crystal material comprises liquid crystal molecules 40.

Wherein the flexible branched chains contained in the active monomers 30 are at least one of:

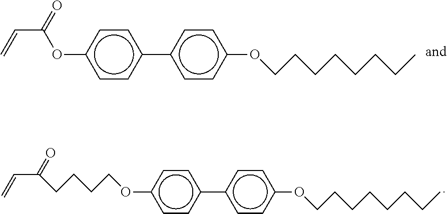

wherein the photoinitiator is one of azobisisobutyronitrile, dialkyl peroxides, diacyl peroxides, peroxy esters, and any combination thereof.

In relation to the liquid crystal medium composition, a mass percentage of the liquid crystal material is 94.5%-98.9%, a mass percentage of the active monomers is 1%-5%, and a mass percentage of the photoinitiator is 0.1%-0.5%.

In step S102, dripping the liquid crystal medium composition onto one of the upper substrate 10 and the lower substrate 20, coating a sealant 50 on a region of the other of the lower substrate 20 or the upper substrate 10 corresponding to a periphery of the liquid crystal medium composition, assembling and attaching the upper substrate 10 with the lower substrate 20, and curing the sealant 50, wherein a liquid crystal layer 60 is formed by the liquid crystal medium composition disposed between the upper substrate 10 and the lower substrate 20.

Specifically, the sealant can be cured by adopting a heating or ultraviolet irradiation method.

Preferably, the step S102 further comprises coating a conductive adhesive 70 on the lower substrate 20 or the upper substrate 10 corresponding to the periphery of the sealing adhesive 50 before the upper substrate 10 and the lower substrate 20 are attached to each other.

Preferably, assembling and attaching the upper substrate 10 with the lower substrate 20 in a vacuum environment.

Specifically, the upper substrate 10 is a CF substrate, and the lower substrate 20 is a TFT substrate. A side of the upper substrate 10 which is close to the liquid crystal layer 60 is a common electrode 80. A side of the lower substrate 10 which is close to the liquid crystal layer is a pixel electrode 90.

Please refer to FIG. 3, where FIG. 3 is a schematic diagram of step S103 of the method for manufacturing a liquid crystal display panel of the embodiment of the present disclosure. In step S103, heating the liquid crystal layer 60, and after a conformation of the liquid crystal molecule 40 changes, applying a first ultraviolet irradiation to the liquid crystal layer 60 while heating, such that a portion of the active monomers 30 react with the photoinitiator and the active monomers are deposited on both the upper substrate 10 and the lower substrate 20, and the liquid crystal molecules 40 are aligned perpendicular to the upper substrate 10 and the lower substrate 20.

Specifically, the liquid crystal layer is heated to a temperature of 70° C. to 100° C.; a duration for applying the first ultraviolet light irradiation to the liquid crystal layer 60 is between 1 minute to 60 minutes; and the intensity of the first ultraviolet irradiation on the liquid crystal layer 60 is between 85 mW/cm² to 100 mW/cm²

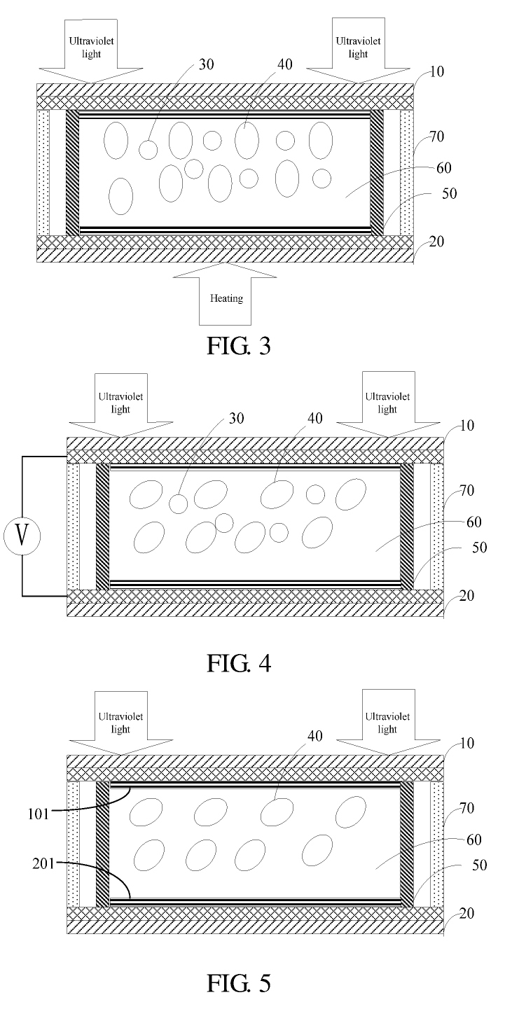

Please refer to FIG. 4. FIG. 4 is a schematic diagram of step S103 of the method for manufacturing a liquid crystal display panel of the embodiment of the present disclosure. In step S104, applying a voltage to two sides of the liquid crystal layer 60, and after the liquid crystal molecules 40 are deflected, applying a second ultraviolet irradiation to the liquid crystal layer 60 while applying the voltage, such that another portion of the active monomers 30 react with the photoinitiator, causing continued deposition of the active monomers on both the upper substrate 10 and the lower substrate 20, and the liquid crystal molecules 40 generate a pretilt angle.

Specifically, the voltage applied to the two sides of the liquid crystal layer 60 is 13-25 V; the duration for applying the second ultraviolet light irradiation to the liquid crystal layer 60 is between 30 seconds to 200 seconds; and the intensity for applying the second ultraviolet light irradiation to the liquid crystal layer 60 is between 85 mW/cm² to 100 mW/cm².

Please further refer to FIG. 1, where the manufacturing method of the liquid crystal display panel provided by the embodiment of the present disclosure further comprises step S105: removing the voltage which is applied to the two sides of the liquid crystal layer, and then applying a third ultraviolet irradiation to the liquid crystal layer, such that the active monomers completely react with the photoinitiator.

Please refer to FIG. 5, where FIG. 5 is a schematic diagram of step S105 of the method for manufacturing a liquid crystal display panel of the embodiment of the present disclosure. In step S105, removing the voltage which is applied to the two sides of the liquid crystal layer 60, and then applying a third ultraviolet irradiation to the liquid crystal layer 60, such that the active monomers 30 completely react with the photoinitiator and the active monomers 30 continue to be deposited on both the surface of the upper substrate 10 and the surface of the lower substrate 20.

Specifically, the duration for applying the third ultraviolet light irradiation to the liquid crystal layer is between 30 minutes to 100 minutes; and the intensity of the third ultraviolet irradiation of the liquid crystal layer 60 is between 85 mW/cm² to 100 mW/cm².

Please refer to FIG. 3, FIG. 4, and FIG. 5 together, where the first ultraviolet irradiation, the second ultraviolet irradiation, and the third ultraviolet light, the active monomers 30 react with the photoinitiator and forms a first polymer layer 101 and a second polymer layer 201 on the upper substrate and the lower substrate, respectively, wherein a thickness of each of the first polymer layer 101 and the second polymer layer 201 is between 200 angstroms to 1200 angstroms.

The present disclosure provides a manufacturing method of the liquid crystal display panel and a liquid crystal medium composition. A photoinitiator and flexible branched chains-containing active monomers are added into the liquid crystal material, and a special process condition is used. Thus, a traditional alignment film process can be omitted, and liquid crystal alignment is accomplished. Furthermore, impurity ions are prevented from diffusing into a liquid crystal layer, and quality of the liquid crystal display panel is greatly enhanced.

Specific examples are used herein to describe the principle and implementations of the present disclosure. The descriptions of the foregoing embodiments are merely for understanding the present disclosure. In addition, with respect to the implementations and the application scope, modifications may be made by a person of ordinary skill in the art according to the idea of the present disclosure. Therefore, this specification shall not be construed as a limitation on the present disclosure.

1. A manufacturing method of a liquid crystal display panel, comprising steps of:
providing an upper substrate, a lower substrate, and a liquid crystal medium composition, wherein the liquid crystal medium composition comprises a liquid crystal material, a photoinitiator, and flexible branched chains-containing active monomers, wherein the liquid crystal material comprises liquid crystal molecules;
dripping the liquid crystal medium composition onto one of the upper substrate and the lower substrate, coating a sealant on a region of the upper substrate and the lower substrate corresponding to a periphery of the liquid crystal medium composition, assembling and attaching the upper substrate with the lower substrate, and curing the sealant, wherein a liquid crystal layer is formed by the liquid crystal medium composition which is disposed between the upper substrate and the lower substrate;
heating the liquid crystal layer, and after a conformation of the liquid crystal molecule changes, applying a first ultraviolet irradiation to the liquid crystal layer while heating, such that a portion of the active monomers react with the photoinitiator and the active monomers are deposited on both the upper substrate and the lower substrate, thus aligning the liquid crystal molecules perpendicular to the upper substrate and the lower substrate; and
applying a voltage to two sides of the liquid crystal layer, and after the liquid crystal molecules are deflected, applying a second ultraviolet irradiation to the liquid crystal layer while applying the voltage, such that another portion of the active monomers react with the photoinitiator, causing continued deposition of the active monomers on both the upper substrate and the lower substrate, thus having the liquid crystal molecules generate a pretilt angle;
wherein after the step of applying voltage to the two sides of the liquid crystal layer, and after the liquid crystal molecules are deflected, applying the second ultraviolet irradiation to the liquid crystal layer while applying the voltage, such that the another portion of the active monomers react with the photoinitiator, causing continued deposition of the active monomers on both the upper substrate and the lower substrate, thus having the liquid crystal molecules generate the pretilt angle, the method further comprises:
removing the voltage which is applied to the two sides of the liquid crystal layer, and then applying a third ultraviolet irradiation to the liquid crystal layer, such that the active monomers completely react with the photoinitiator; and
wherein in relation to the liquid crystal medium composition, a mass percentage of the liquid crystal material is 94.5%-98.9%, a mass percentage of the active monomers is 1%-5%, and a mass percentage of the photoinitiator is 0.1%-0.5%.

2. The manufacturing method of the liquid crystal display panel according to claim 1, wherein a duration for applying the first ultraviolet light irradiation to the liquid crystal layer is between 1 minute to 60 minutes, and a duration for applying the second ultraviolet light irradiation to the liquid crystal layer is between 30 seconds to 200 seconds, and a duration for applying the third ultraviolet light irradiation to the liquid crystal layer is between 30 minutes to 100 minutes.

3. The manufacturing method of the liquid crystal display panel according to claim 1, wherein the first ultraviolet irradiation, the second ultraviolet light irradiation, and the third ultraviolet light irradiation cause the active monomers to react with the photoinitiator, and a first polymer layer and a second polymer layer are formed on the upper substrate and the lower substrate, respectively, wherein a thickness of each of the first polymer layer and the second polymer layer is between 200 angstroms to 1200 angstroms.

4. The manufacturing method of the liquid crystal display panel according to claim 1, wherein the active monomers are at least one of:

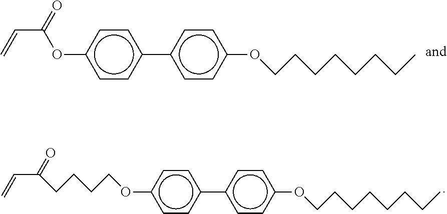

5. The manufacturing method of the liquid crystal display panel according to claim 1, wherein the photoinitiator is one of azobisisobutyronitrile, dialkyl peroxides, diacyl peroxides, peroxy esters, and any combination thereof.

6. The manufacturing method of the liquid crystal display panel according to claim 1, wherein the liquid crystal layer is heated to a temperature of 70° C. to 100° C.

7. The manufacturing method of the liquid crystal display panel according to claim 1, wherein an intensity of each of the first ultraviolet light irradiation, the second ultraviolet light irradiation and the third ultraviolet light irradiation is between 85 mW/cm² to 100 mW/cm².

8. A manufacturing method of the liquid crystal display panel, comprises steps of:
providing an upper substrate, a lower substrate, and a liquid crystal medium composition, wherein the liquid crystal medium composition comprises a liquid crystal material, a photoinitiator, and flexible branched chains-containing active monomers, wherein the liquid crystal material comprises liquid crystal molecules;
dripping the liquid crystal medium composition onto one of the upper substrate and the lower substrate, coating a sealant on a region of the upper substrate and the lower substrate corresponding to a periphery of the liquid crystal medium composition, assembling and attaching the upper substrate with the lower substrate, and curing the sealant, wherein a liquid crystal layer is formed by the liquid crystal medium composition which is disposed between the upper substrate and the lower substrate;
heating the liquid crystal layer, and after a conformation of the liquid crystal molecule changes, applying a first ultraviolet irradiation to the liquid crystal layer while heating, such that a portion of the active monomers react with the photoinitiator and the active monomers are deposited on both the upper substrate and the lower substrate, and thus aligning the liquid crystal molecules perpendicular to the upper substrate and the lower substrate; and
applying a voltage to two sides of the liquid crystal layer, and after the liquid crystal molecules are deflected, applying a second ultraviolet irradiation to the liquid crystal layer while applying the voltage, such that another portion of the active monomers react with the photoinitiator, causing continued deposition of the active monomers on both the upper substrate and the lower substrate, and the liquid crystal molecules generate a pretilt angle.

9. The manufacturing method of the liquid crystal display panel according to claim 8, wherein after the step of applying voltage to the two sides of the liquid crystal layer, and after the liquid crystal molecules are deflected, applying the second ultraviolet irradiation to the liquid crystal layer while applying the voltage, such that the another portion of the active monomers react with the photoinitiator, causing continued deposition of the active monomers on both the upper substrate and the lower substrate, thus having the liquid crystal molecules generate the pretilt angle, the method further comprises:
removing the voltage which is applied to the two sides of the liquid crystal layer, and then applying a third ultraviolet irradiation to the liquid crystal layer, such that the active monomers completely react with the photoinitiator.

10. The manufacturing method of the liquid crystal display panel according to claim 9, wherein a duration for applying the first ultraviolet light irradiation to the liquid crystal layer is between 1 minute to 60 minutes, and a duration for applying the second ultraviolet light irradiation to the liquid crystal layer is between 30 seconds to 200 seconds, and a duration for applying the third ultraviolet light irradiation to the liquid crystal layer is between 30 minutes to 100 minutes.

11. The manufacturing method of the liquid crystal display panel according to claim 9, wherein the first ultraviolet irradiation, the second ultraviolet light irradiation, and the third ultraviolet light irradiation cause the active monomers to react with the photoinitiator, and a first polymer layer and a second polymer layer are formed on the upper substrate and the lower substrate, respectively, wherein a thickness of each of the first polymer layer and the second polymer layer is between 200 angstroms to 1200 angstroms.

12. The manufacturing method of the liquid crystal display panel according to claim 8, wherein in relation to the liquid crystal medium composition, a mass percentage of the liquid crystal material is 94.5%-98.9%, a mass percentage of the active monomers is 1%-5%, and a mass percentage of the photoinitiator is 0.1%-0.5%.

13. The manufacturing method of the liquid crystal display panel according to claim 8, wherein the active monomers are at least one of:

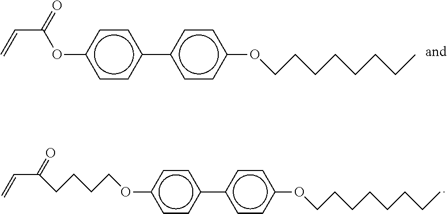

14. The manufacturing method of the liquid crystal display panel according to claim 8, wherein the photoinitiator is one of azobisisobutyronitrile, dialkyl peroxides, diacyl peroxides, peroxy esters, and any combination thereof.

15. The manufacturing method of the liquid crystal display panel according to claim 8, wherein the liquid crystal layer is heated to a temperature of 70° C. to 100° C.

16. The manufacturing method of the liquid crystal display panel according to claim 9, wherein an intensity of each of the first ultraviolet light irradiation, the second ultraviolet light irradiation and the third ultraviolet light irradiation is between 85 mW/cm² to 100 mW/cm².

17. A liquid crystal medium composition, comprising:
a liquid crystal material, a photoinitiator, and flexible branched chains-containing active monomers, wherein the liquid crystal material comprises liquid crystal molecules;
wherein the active monomers are at least one of: 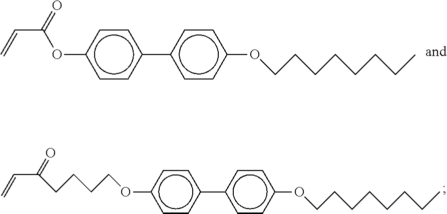
wherein the photoinitiator is one of azobisisobutyronitrile, dialkyl peroxides, diacyl peroxides, peroxy esters, and any combination thereof; and
wherein in relation to the liquid crystal medium composition, a mass percentage of the liquid crystal material is 94.5%-98.9%, a mass percentage of the active monomers is 1%-5%, and a mass percentage of the photoinitiator is 0.1%-0.5%.
